(19) United States
(12) Patent Application Publication
(10) Pub. No.: US 2012/0234502 A1
(43) Pub. Date: Sep. 20, 2012

(54) MAGNETICALLY OPERATED CURTAIN

(75) Inventor: Ju-Huai CHEN, Changhua County (TW)

(73) Assignee: CHICOLOGY, INC., Ontario (CA)

(21) Appl. No.: 13/051,548

(22) Filed: Mar. 18, 2011

(51) Int. Cl. E06B 9/24

(52) U.S. Cl. 160/84.01

(57) ABSTRACT

A magnetically operated curtain includes a curtain fabric, at least a magnetic unit, and at least a metallic unit. The magnetic unit is coupled to a first selected point of the curtain fabric. The metallic unit is coupled to a second selected point of the curtain fabric in a manner that the second selected point is of a specific distance from the magnetic unit. The curtain fabric folds or unfolds as needed under mutual attraction between or separation of the metallic unit and the magnetic unit. The magnetically operated curtain can be used as a window blind, a door curtain, or a sunshade curtain, and can dispense with tractional cords which are indispensable to a conventional window blind (such as a Roman blind). Hence, the magnetically operated curtain not only incurs relatively less costs in a manufacturing process thereof but is easy, quick and safe to use.

### FIELD OF THE INVENTION

The present invention relates to curtains, and more particularly, to a magnetically operated curtain capable of magnetically-operated adjustment of the folding and unfolding of a curtain fabric and suitable for use as a window blind, a door curtain, or a sunshade curtain.

### BACKGROUND OF THE INVENTION

A conventional blind (such as a Roman blind) comprises a hanging blind body. The blind body has a plurality of horizontal slats. The blind body is flanked by tractional cords. Given a complex penetrating structure of the conventional blind, a user can pull one of the tractional cords in order to drive the plurality of horizontal slats to move, thereby allowing the blind body to be lifted or unfolded and lowered. However, pulling the tractional cords for driving the plurality of horizontal slats to move has drawbacks as follows: a complex Roman blind structure, high manufacturing costs, and the phenomenon that a user with a weak muscular strength finds it hard to pull the tractional cords due to their friction or entanglement. Furthermore, due to the conspicuous positions of the tractional cords, toddlers are likely to put the tractional cords on their necks out of curiosity or during an inadvertent act committed in play. With a tractional cord on the neck, a toddler may end up in strangulation. For this reason, most of the countries around the world are going to amended the laws or regulations governing conventional blind usage safety, for example, by restricting the use of tractional cords in conventional blinds.

### SUMMARY OF THE INVENTION

In view of the drawbacks of the conventional blinds, the inventor of the present invention conducted extensive researches and experiments according to the inventor's years of experience in the related industry, and finally developed a magnetically operated curtain which not only incurs relatively less costs in a manufacturing process thereof but is easy, quick and safe to use.

It is a primary objective of the present invention to provide a magnetically operated curtain comprising a curtain fabric to which at least a magnetic unit and at least a metallic unit are coupled, so as to enable a user to control the attraction or separation of the at least a metallic unit and the at least a magnetic unit, such that the magnetically operated curtain not only incurs relatively less costs in a manufacturing process thereof but is easy, quick and safe to use.

In order to achieve the above and other objectives, the present invention provides a magnetically operated curtain, comprising: a curtain fabric having an upper end, a lower end, and a fabric proper; at least a magnetic unit coupled to a first selected point of the fabric proper of the curtain fabric; and at least a metallic unit coupled to a second selected point of the fabric proper of the curtain fabric in a manner that the second selected point is of a specific distance from the magnetic unit, such that the curtain fabric folds under mutual attraction between the at least a metallic unit and the at least a magnetic unit.

In a preferred embodiment according to the present invention, the magnetically operated curtain comprises multiple said magnetic units spaced apart from each other and coupled to the fabric proper of the curtain fabric, and a said metallic unit coupled to the fabric proper of the curtain fabric and positioned proximate to the lower end of the curtain fabric.

In a preferred embodiment according to the present invention, a veil is hung from the upper end of the curtain fabric.

In a preferred embodiment according to the present invention, the magnetically operated curtain comprises multiple said magnetic units spaced apart from each other and coupled to the fabric proper of the curtain fabric, a said metallic unit coupled to the fabric proper of the curtain fabric and positioned proximate to the lower end of the curtain fabric, and a said magnetic unit coupled to the veil.

In a preferred embodiment according to the present invention, the magnetic unit comprises an elongate rod transversely coupled to the curtain fabric and at least a magnet coupled to the elongate rod. The elongate rod is a hollow tube, and the magnet is disposed in and coupled to the hollow tube. Alternatively, the elongate rod is a U-shaped tube, and the magnet is disposed in and coupled to the U-shaped tube. Alternatively, the elongate rod is a C-shaped tube with a slit, and the magnet is disposed in and coupled to the C-shaped tube.

In a preferred embodiment according to the present invention, the metallic unit comprises at least a metal bar, and the metal bar is transversely coupled to the curtain fabric.

In a preferred embodiment according to the present invention, the magnetically operated curtain comprises an adjusting stick for adjusting the curtain fabric, and a magnetic body disposed at one end of the adjusting stick.

In a preferred embodiment according to the present invention, to operate a magnetically operated curtain of the present invention, a user holds an adjusting stick, attaches the adjusting stick to a metallic unit by magnetic attraction between the metallic unit and a magnetic unit, so as for a curtain fabric to fold and rise. Conversely, the user can separate the metallic unit and the magnetic unit to unfold and lower the curtain fabric. Accordingly, the magnetically operated curtain not only incurs relatively less costs in a manufacturing process thereof but is easy, quick and safe to use.

### BRIEF DESCRIPTION OF THE DRAWINGS

To enable persons skilled in the art to fully understand the objectives, features, and advantages of the present invention, the present invention is hereunder illustrated with specific embodiments in conjunction with the accompanying drawings, in which:

FIG. 1 is a perspective view of a magnetically operated curtain according to a first preferred embodiment of the present invention;

FIG. 2 is a perspective view of a magnetically operated curtain according to a second preferred embodiment of the present invention;

FIG. 3 is a partial perspective view of a magnetic unit according to the first preferred embodiment of the present invention;

FIG. 4 is a partial perspective view of a magnetic unit according to the second preferred embodiment of the present invention;

FIG. 5 is a partial perspective view of a magnetic unit according to a third preferred embodiment of the present invention;

FIG. 6 is a schematic view of operation of a magnetically operated curtain according to an exemplary preferred embodiment of the present invention; and

FIG. 7 is a schematic view showing how to fold a magnetically operated curtain according to an exemplary preferred embodiment of the present invention.

### DETAILED DESCRIPTION OF THE PREFERRED EMBODIMENTS

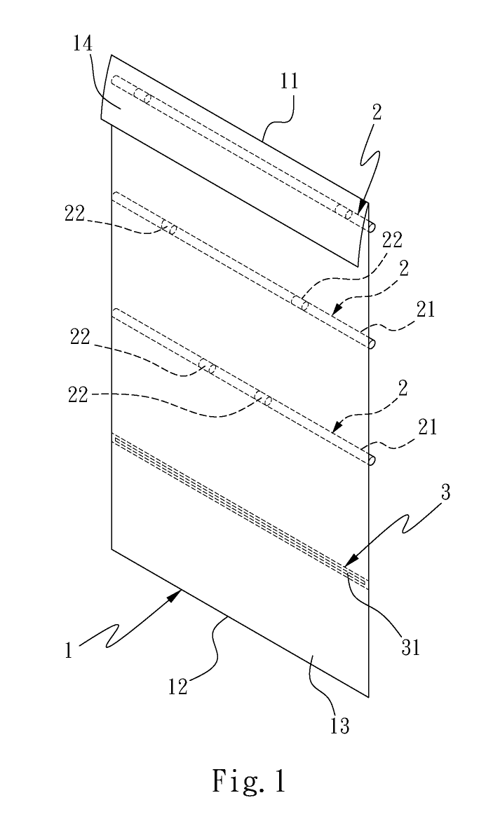

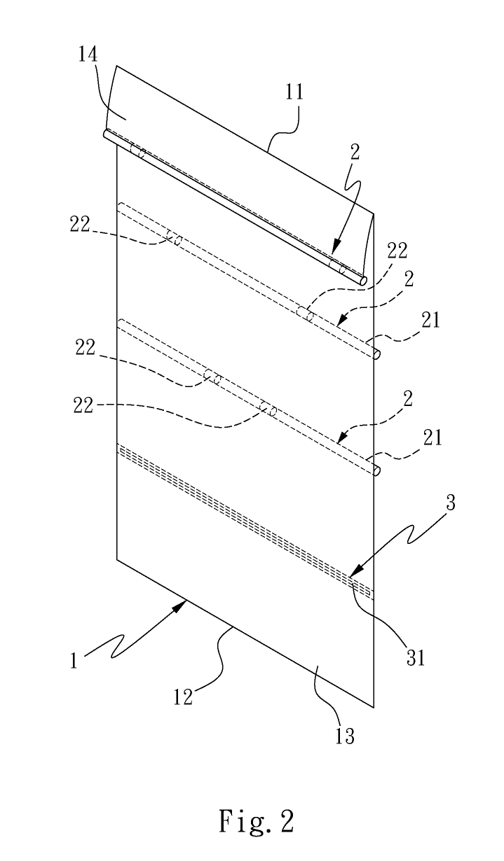

Referring to FIG. 1 and FIG. 2, in a preferred embodiment of the present invention, a magnetically operated curtain comprises a curtain fabric 1, at least a magnetic unit 2, and at least a metallic unit 3, and is characterized in that: the curtain fabric 1 has an upper end 11, a lower end 12, and a fabric proper 13, and is made of a woven fabric, a non-woven fabric, a plastic fabric, or a bamboo mat. The at least a magnetic unit 2 is coupled to a first selected point of the curtain fabric 1. For example, the at least a magnetic unit 2 is coupled to at least one of the upper end 11, the lower end 12, and the fabric proper 13 of the curtain fabric 1. The at least a metallic unit 3 is coupled to a second selected point of the curtain fabric 1 in a manner that the second selected point is of a specific distance from the at least a magnetic unit 2. In doing so, the at least a metallic unit 3 can be attracted to and/or separated from the at least a magnetic unit 2 as needed, so as to fold and/or unfold the curtain fabric 1. Accordingly, the magnetically operated curtain of the present invention can be used as a window blind, a door curtain, or a sunshade curtain.

Referring to FIG. 1, in a preferred embodiment of the present invention, the arrangement and positions of the at least a magnetic unit 2 and the at least a metallic unit 3 relative to the curtain fabric 1 are described as follows: multiple said magnetic units 2 are spaced apart from each other and coupled to the fabric proper 13 of the curtain fabric 1, and a said metallic unit 3 is coupled to the fabric proper 13 of the curtain fabric 1 and positioned proximate to the lower end 12 of the curtain fabric 1, such that the curtain fabric 1 folds and rises under mutual attraction between the metallic unit 3 and at least one of multiple said magnetic units 2.

Referring to FIG. 2, in a preferred embodiment of the present invention, the arrangement and positions of the at least a magnetic unit 2 and the at least a metallic unit 3 relative to the curtain fabric 1 are described as follows: a veil 14 is hung from the upper end 11 of the curtain fabric 1; multiple said magnetic units 2 are spaced apart from each other and coupled to the fabric proper 13 of the curtain fabric 1; a said metallic unit 3 is coupled to the fabric proper 13 of the curtain fabric 1 and positioned proximate to the lower end 12 of the curtain fabric 1; and a said magnetic unit 2 coupled to the veil 14. In doing so, the curtain fabric 1 folds and rises under mutual attraction between the metallic unit 3 and at least one of multiple said magnetic units 2.

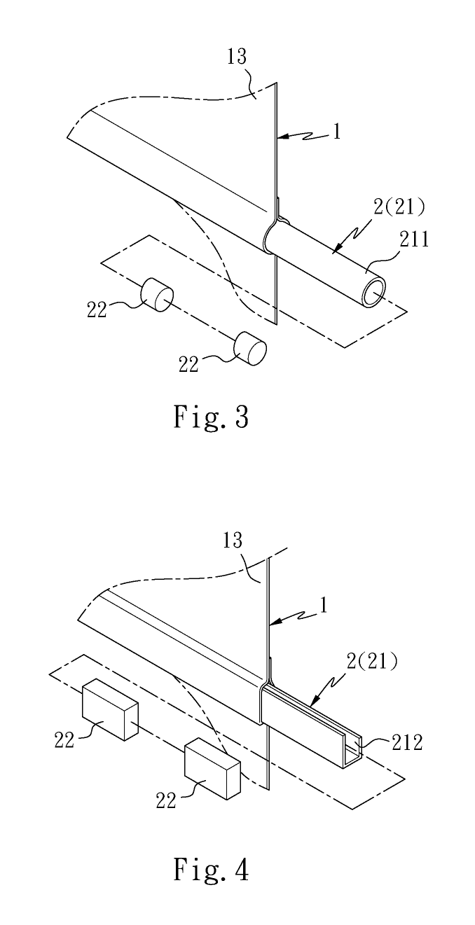

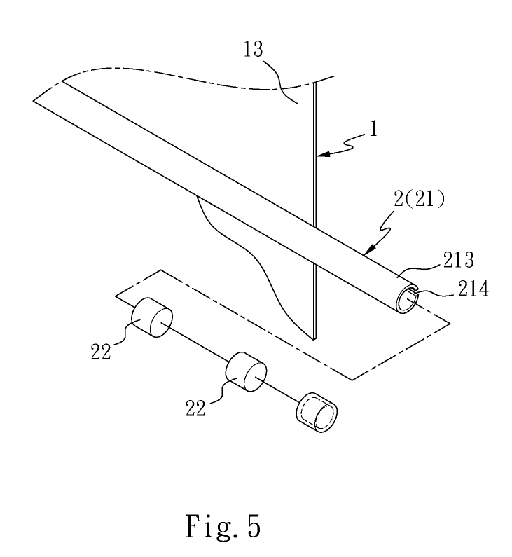

Referring to FIG. 3 through FIG. 5, in a preferred embodiment of the present invention, the magnetic unit 2 comprises an elongate rod 21 transversely coupled to the curtain fabric 1 and at least a magnet 22 coupled to the elongate rod 21. As shown in FIG. 3, the elongate rod 21 is a hollow tube 211, and the magnet 22 is disposed in and coupled to the hollow tube 211. As shown in FIG. 4, the elongate rod 21 is a U-shaped tube 212, and the magnet 22 is disposed in and coupled to the U-shaped tube 212. As shown in FIG. 5, the elongate rod 21 is a C-shaped tube 213 with a slit 214, and the magnet 22 is disposed in and coupled to the C-shaped tube 213. In doing so, with the elongate rod 21 being coupled to the curtain fabric 1 from outside or being enclosed by the curtain fabric 1, the magnet 22 enables the elongate rod 21 to be drawn close to and/or separated from the metallic unit 3 as needed.

Referring to FIG. 1 and FIG. 2, in a preferred embodiment of the present invention, the metallic unit 3 comprises at least a metal bar 31. The at least a metal bar 31 is transversely coupled to the curtain fabric 1 in a manner that the at least a metal bar 31 is coupled to the curtain fabric 1 from outside and/or enclosed by the curtain fabric 1. In doing so, the at least a metal bar 31 enables the metallic unit 3 to be drawn close to and/or separated from the magnetic unit 2 as needed.

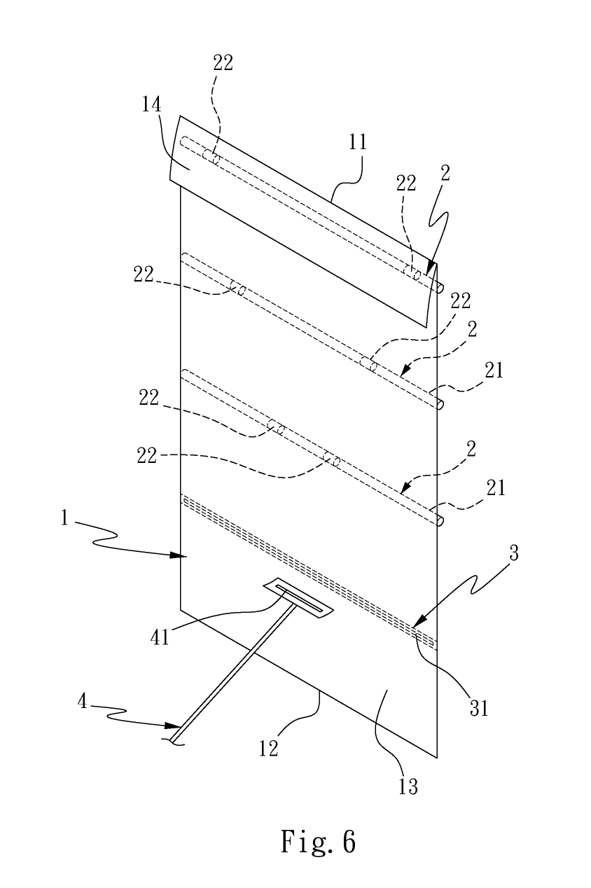

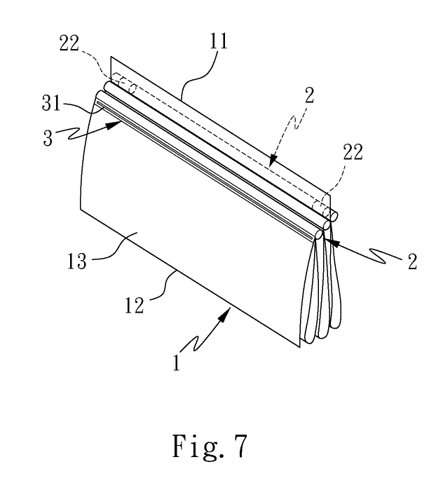

Referring to FIG. 6, the magnetically operated curtain of the present invention further comprises an adjusting stick 4 for adjusting the curtain fabric 1, and a magnetic body 41 disposed at one end of the adjusting stick 4. The adjusting stick 4 and the magnetic body 41 together enable the metallic unit 3 to be attracted to and/or separated from the magnetic unit 2 as needed.

Referring to FIG. 6, to operate the magnetically operated curtain of the present invention, a user holds the adjusting stick 4, attaches the magnetic body 41 of the adjusting stick 4 to the metallic unit 3 (metal bar 31) by magnetic attraction, moves the curtain fabric 1 upward by means of the adjusting stick 4, and controllably allows the metallic unit 3 (metal bar 31) to be attracted to at least one of the magnetic units 2 (magnets 22) as needed; in doing so, the curtain fabric 1 folds and rises in a changeable manner according to the position of attraction such that, eventually, the curtain fabric 1 is partly folded, half folded, or, as shown in FIG. 7, fully folded. Conversely, the user can unfold and lower the curtain fabric 1 by separating the metallic unit 3 (metal bar 31) from the magnetic unit 2 (magnet 22), using the adjusting stick 4. Hence, the magnetically operated curtain of the present invention dispenses with tractional cords which are indispensable to a conventional window blind (such as a Roman blind), such that the magnetically operated curtain not only incurs relatively less costs in a manufacturing process thereof but is easy, quick and safe to use. Operating without any tractional cords which are indispensable to a conventional window blind (such as a Roman blind), the magnetically operated curtain of the present invention enhance the safety of children which until now has been at risk of accessing the insidiously dangerous tractional cords.

Hence, the present invention meets the three requirements of patentability, namely novelty, non-obviousness, and industrial applicability. Regarding novelty and non-obviousness, the present invention discloses a curtain fabric to which at least a magnetic unit and at least a metallic unit are coupled, so as to enable a user to control the attraction or separation of the metallic unit and the magnetic unit, such that the magnetically operated curtain not only incurs relatively less costs in a manufacturing process thereof but is easy, quick and safe to use. Regarding industrial applicability, products derived from the present invention meet existing market demands fully.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A magnetically operated curtain, comprising:
a curtain fabric having an upper end, a lower end, and a fabric proper;
at least a magnetic unit coupled to a first selected point of the fabric proper of the curtain fabric; and
at least a metallic unit coupled to a second selected point of the fabric proper of the curtain fabric in a manner that the second selected point is of a specific distance from the magnetic unit, such that the curtain fabric folds under mutual attraction between the metallic unit and the magnetic unit.

2. The magnetically operated curtain of claim 1, further comprising multiple said magnetic units spaced apart from each other and coupled to the fabric proper of the curtain fabric, and a said metallic unit coupled to the fabric proper of the curtain fabric and positioned proximate to the lower end of the curtain fabric.

3. The magnetically operated curtain of claim 1, wherein a veil is hung from the upper end of the curtain fabric.

4. The magnetically operated curtain of claim 3, further comprising multiple said magnetic units spaced apart from each other and coupled to the fabric proper of the curtain fabric, a said metallic unit coupled to the fabric proper of the curtain fabric and positioned proximate to the lower end of the curtain fabric, and a said magnetic unit coupled to the veil.

5. The magnetically operated curtain of claim 1, wherein the magnetic unit comprises an elongate rod transversely coupled to the curtain fabric and at least a magnet coupled to the elongate rod.

6. The magnetically operated curtain of claim 2, wherein the magnetic unit comprises an elongate rod transversely coupled to the curtain fabric and at least a magnet coupled to the elongate rod.

7. The magnetically operated curtain of claim 4, wherein the magnetic unit comprises an elongate rod transversely coupled to the curtain fabric and at least a magnet coupled to the elongate rod.

8. The magnetically operated curtain of claim 5, wherein the elongate rod is a hollow tube, and the magnet is disposed in and coupled to the hollow tube.

9. The magnetically operated curtain of claim 6, wherein the elongate rod is a hollow tube, and the magnet is disposed in and coupled to the hollow tube.

10. The magnetically operated curtain of claim 7, wherein the elongate rod is a hollow tube, and the magnet is disposed in and coupled to the hollow tube.

11. The magnetically operated curtain of claim 5, wherein the elongate rod is a U-shaped tube, and the magnet is disposed in and coupled to the U-shaped tube.

12. The magnetically operated curtain of claim 6, wherein the elongate rod is a U-shaped tube, and the magnet is disposed in and coupled to the U-shaped tube.

13. The magnetically operated curtain of claim 7, wherein the elongate rod is a U-shaped tube, and the magnet is disposed in and coupled to the U-shaped tube.

14. The magnetically operated curtain of claim 5, wherein the elongate rod is a C-shaped tube with a slit, and the magnet is disposed in and coupled to the C-shaped tube.

15. The magnetically operated curtain of claim 6, wherein the elongate rod is a C-shaped tube with a slit, and the magnet is disposed in and coupled to the C-shaped tube.

16. The magnetically operated curtain of claim 7, wherein the elongate rod is a C-shaped tube with a slit, and the magnet is disposed in and coupled to the C-shaped tube.

17. The magnetically operated curtain of claim 1, wherein the metallic unit comprises at least a metal bar transversely coupled to the curtain fabric.

18. The magnetically operated curtain of claim 2, wherein the metallic unit comprises at least a metal bar transversely coupled to the curtain fabric.

19. The magnetically operated curtain of claim 4, wherein the metallic unit comprises at least a metal bar transversely coupled to the curtain fabric.

20. The magnetically operated curtain of claim 1, further comprising an adjusting stick for adjusting the curtain fabric, and a magnetic body disposed at an end of the adjusting stick.
